(19) United States
(12) Patent Application Publication
(10) Pub. No.: US 2025/0214421 A1
(43) Pub. Date: Jul. 3, 2025

(54) VEHICLE AND METHOD OF CONTROLLING THE SAME

(71) Applicants: HYUNDAI MOTOR COMPANY, Seoul (KR); Kia Corporation, Seoul (KR); HYUNDAI WIA CORPORATION, Changwon-si (KR)

(72) Inventors: Tae Hyung LEE, Hwaseong-si (KR); Siyoung SONG, Hwaseong-si (KR); Taewoo LEE, Suwon-si (KR); Hyeok Hun SONG, Hanam-si (KR)

(73) Assignees: HYUNDAI MOTOR COMPANY, Seoul (KR); Kia Corporation, Seoul (KR); HYUNDAI WIA CORPORATION, Changwon-si (KR)

(21) Appl. No.: 18/733,391

(22) Filed: Jun. 4, 2024

(30) Foreign Application Priority Data
Dec. 29, 2023 (KR) 10-2023-0197137

(51) Int. Cl. B60K 23/04; B60W 40/068; B60W 40/13

(52) U.S. Cl. CPC B60K 23/04; B60W 40/068; B60W 40/13; B60K 2023/043

(57) ABSTRACT

In a vehicle and a method of controlling the same, the vehicle may include: a first electric limited slip differential provided on a first driveshaft, and limiting differential actions of a left wheel and a right wheel of the first driveshaft; a second electric limited slip differential provided on a second driveshaft, and limiting differential actions of a left wheel and a right wheel of the second driveshaft; and a controller operatively connected to the first and second electric limited slip differentials and configured for controlling a torque limit value of the first electric limited slip differential and a torque limit value of the second electric limited slip differential based on a difference between an axial load of the first driveshaft and an axial load of the second driveshaft.

### CROSS-REFERENCE TO RELATED APPLICATION

The present application claims priority to Korean Patent Application No. 10-2023-0197137 filed on Dec. 29, 2023, the entire contents of which is incorporated herein for all purposes by this reference.

### BACKGROUND OF THE PRESENT DISCLOSURE

### Field of the Present Disclosure

The present disclosure relates to a vehicle and a method of controlling the same, and more particularly, to a vehicle in which an electric limited slip differential is provided in a main driving wheel and an auxiliary driving wheel, and a method of controlling the same.

### Description of Related Art

In general, a differential apparatus provided in a vehicle allows left and right wheels to rotate at different velocities when the vehicle is turn-driven.

However, in a situation in which tractions of left and right driving wheels are different from each other, the differential apparatus distributes more power to a driving wheel having smaller traction and cannot transfer sufficient power to a driving wheel having relatively large traction. That is, there is a situation in which the left and right driving wheels cannot be smoothly controlled by the differential apparatus in the situation in which the tractions of the left and right driving wheels are different from each other.

To solve such a problem, a limited slip differential (LSD) is used, which limits a differential of the left and right driving wheels. The type of LSD includes Torsen LSD, Biscus LSD, and multi-disk clutch type LSD, etc.

The LSD in the related art is mounted on a driveshaft of a main driving wheel of the vehicle, and serves to limit the differential of the left and right driving wheels.

When the LSD is mounted on a four-wheel drive vehicle, the maximum driving force of the main driving wheel (e.g., a rear wheel of a rear wheel drive vehicle) may be used by inhibiting a wheel spin of the main driving wheel by the LSD. However, because the LSD is not mounted on an auxiliary driving wheel (e.g., a front wheel of the rear wheel drive vehicle), there is a limit in which total driving force of the vehicle cannot be sufficiently utilized.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a vehicle and a method of controlling the same, which can enhance driving performance of a vehicle upon straight driving and turn driving by limiting differentials of a main driving wheel and an auxiliary driving wheel, respectively.

An exemplary embodiment of the present disclosure provides a vehicle which may include: a first electric limited slip differential provided on a first driveshaft, and limiting differential actions of a left wheel and a right wheel of the first driveshaft; a second electric limited slip differential provided on a second driveshaft, and limiting differential actions of a left wheel and a right wheel of the second driveshaft; and a controller operatively connected to the first and second electric limited slip differentials and configured for controlling a torque limit value of the first electric limited slip differential and a torque limit value of the second electric limited slip differential based on a difference between an axial load of the first driveshaft and an axial load of the second driveshaft.

In some exemplary embodiments of the present disclosure, when a difference between the axial load of the first driveshaft and the axial load of the second driveshaft is less than a predetermined value, the controller may set the torque limit value of the first electric limited slip differential to a maximum torque, and set the torque limit value of the second electric limited slip differential to the maximum torque.

In some exemplary embodiments of the present disclosure, when the difference between the axial load of the first driveshaft and the axial load of the second driveshaft is equal to or greater than the predetermined value, the controller may set a torque limit value of an electric limited slip differential provided in a driveshaft including a larger axial load between the first driveshaft and the second driveshaft to the maximum torque, and set a torque limit value of an electric limited slip differential provided in a driveshaft including a smaller axial load between the first driveshaft and the second driveshaft to a limited torque smaller than the maximum torque.

In some exemplary embodiments of the present disclosure, the limited torque may be determined by the maximum torque of the electric limited slip differential by an axial load ratio gain determined according to the axial load of the first driveshaft and the axial load of the second driveshaft, and a friction coefficient gain determined according to a road surface friction coefficient of a road.

In some exemplary embodiments of the present disclosure, the limited torque may be determined through an equation of Tₗᵢₘ=Cf*Cm*Tₘₐₓ, and where Tₗᵢₘ may represent the limited torque, Cf may represent an axial load ratio gain, Cm may represent the friction coefficient gain, and Tₘₐₓ may represent the maximum torque of the electric limited slip differential.

In some exemplary embodiments of the present disclosure, the axial load ratio gain may decrease as a ratio of the axial load of the first driveshaft and the axial load of the second driveshaft decreases.

In some exemplary embodiments of the present disclosure, the friction coefficient gain may decrease as the road surface friction coefficient of the road decreases.

Another exemplary embodiment of the present disclosure provides a method of controlling a vehicle, which may include: comparing an axial load of a first driveshaft and an axial load of a second driveshaft; and controlling a torque limit value of a first electric limited slip differential ‘provided on the first driveshaft and a torque limit value of a second electric limited slip differential provided on the second driveshaft based on a difference between the axial load of the first driveshaft and the axial load of the second driveshaft.

In some exemplary embodiments of the present disclosure, when a difference between the axial load of the first driveshaft and the axial load of the second driveshaft is less than a predetermined value, the torque limit value of the first electric limited slip differential may be set to a maximum torque, and the torque limit value of the second electric limited slip differential may be set to the maximum torque.

In some exemplary embodiments of the present disclosure, when the difference between the axial load of the first driveshaft and the axial load of the second driveshaft is equal to or greater than the predetermined value, a torque limit value of an electric limited slip differential provided in a driveshaft including a larger axial load between the first driveshaft and the second driveshaft may be set to the maximum torque, and a torque limit value of an electric limited slip differential provided in a driveshaft including a smaller axial load between the first driveshaft and the second driveshaft may be set to a limited torque smaller than the maximum torque.

In some exemplary embodiments of the present disclosure, the limited torque may be determined by the maximum torque of the electric limited slip differential by an axial load ratio gain determined according to the axial load of the first driveshaft and the axial load of the second driveshaft, and a friction coefficient gain determined according to a road surface friction coefficient of a road.

In some exemplary embodiments of the present disclosure, the limited torque may be determined through an equation of Tₗᵢₘ=Cf*Cm*Tₘₐₓ, and where Tₗᵢₘ may represent the limited torque, Cf may represent an axial load ratio gain, Cm may represent the friction coefficient gain, and Tₘₐₓ may represent the maximum torque of the electric limited slip differential.

In some exemplary embodiments of the present disclosure, the axial load ratio gain may decrease as a ratio of the axial load of the first driveshaft and the axial load of the second driveshaft decreases.

In some exemplary embodiments of the present disclosure, the friction coefficient gain may decrease as the road surface friction coefficient of the road decreases.

According to exemplary embodiments of the present disclosure, by adjusting torque limit values of first and second limited slip differentials based on loads applied to a driveshaft of a front wheel and a driveshaft of a rear wheel of a vehicle, driving performances upon traction driving and turn driving of the vehicle may be enhanced.

Besides, an effect which may be obtained or predicted by the exemplary embodiment of the present disclosure is directly or implicitly included in detailed description of the exemplary embodiment of the present disclosure. That is, various effects predicted according to the exemplary embodiment of the present disclosure will be included in the detailed description to be described below.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a conceptual view exemplarily illustrating a configuration of a vehicle according to an exemplary embodiment of the present disclosure.

FIG. 2 is a block diagram illustrating the configuration of the vehicle according to an exemplary embodiment of the present disclosure.

FIG. 3 is a flowchart illustrating a method of controlling a vehicle according to an exemplary embodiment of the present disclosure.

FIG. 4 is a diagram illustrating a behavior of the vehicle in a situation in which the method of controlling a vehicle according to an exemplary embodiment of the present disclosure is not applied.

FIG. 5 is a diagram illustrating experimental data in the situation in which the method of controlling a vehicle according to an exemplary embodiment of the present disclosure is not applied.

FIG. 6 is a diagram illustrating the behavior of the vehicle in a situation in which the method of controlling a vehicle according to an exemplary embodiment of the present disclosure is applied.

FIG. 7 is a diagram illustrating the experimental data in the situation in which the method of controlling a vehicle according to an exemplary embodiment of the present disclosure is applied.

FIG. 8 is a diagram describing a determining device according to an exemplary embodiment of the present disclosure.

It may be understood that the appended drawings are not necessarily to scale, presenting a somewhat simplified representation of various features illustrative of the basic principles of the present disclosure. The predetermined design features of the present disclosure as included herein, including, for example, specific dimensions, orientations, locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

The terms used here are only for describing specific exemplary embodiments of the present disclosure, and are not intended to limit the present disclosure. As used herein, the singular forms are also intended to include plural forms, unless they are explicitly differently indicated by context. It will be appreciated that when terms “include” and/or “including” are used in the present specification, the terms “include” and/or “including” are intended to designate the existence of mentioned features, integers, steps, operations, constituent elements, and/or components, but do not exclude the existence or addition of one or more other features, integers, steps, operations, constituent elements, and components, and/or groups thereof. As used herein, the terms “and/or” include any one or all combinations of the items which are associated and listed.

Additionally, it is appreciated that one or more of the following methods or aspects thereof may be executed by one or more controllers 70. The term “controller 70” may refer to a hardware device including a memory and a processor. The memory is configured to store program instructions, and the processor is programmed to execute the program instructions to perform one or more processes which are described below in more detail. As included herein, the controller 70 may be configured for controlling units, modules, portions, devices, or operations of those similar thereto. Furthermore, as recognized by those skilled in the art, it is appreciated that the following methods may be executed by a device including the controller 70 jointly with one or more other components.

Furthermore, the controller 70 of the present disclosure may be implemented as a non-transitory computer readable recording medium including executable program instructions executed by the processor. Examples of computer readable recording media include a ROM, a RAM, a compact disk (CD) ROM, magnetic tapes, floppy disks, flash drives, smart cards, and optical data storage devices, but are not limited thereto. The computer readable recording media are also distributed throughout a computer network, and program instructions may be stored and executed by a distribution scheme such as a telematics server or a controller (70) area network (CAN).

The present disclosure will be described in detail to be easily conducted by those skilled in the art in a field of the present disclosure to which the present disclosure pertains. However, the present disclosure may be realized in various different forms, and is not limited to the exemplary embodiments described herein.

A part irrelevant to the description will be omitted to clearly describe the present disclosure, and the same elements will be designated by the same reference numerals throughout the specification.

Suffixes “module” and/or “unit” for components used in the following description are provided or mixed in consideration of easy preparation of the present disclosure only and do not have their own distinguished meanings or roles.

Furthermore, in describing an exemplary embodiment of the present disclosure, a detailed description of related known technologies will be omitted if it is determined that the detailed description makes the gist of the exemplary embodiment of the present disclosure unclear.

Furthermore, the accompanying drawings are provided for helping to easily understand exemplary embodiments included in the present specification, and the technical spirit included in the present specification is not limited by the accompanying drawings, and it will be appreciated that the present disclosure includes all of the modifications, equivalent matters, and substitutes included in the spirit and the technical scope of the present disclosure.

Terms including an ordinary number, such as first and second, are used for describing various constituent elements, but the constituent elements are not limited by the terms.

In the flowchart described with reference to the drawings, the order of operations may be changed, multiple operations may be merged, or any operation may be divided, and a specific operation may not be performed.

Hereinafter, a vehicle according to various exemplary embodiments of the present disclosure will be described in detail with reference to the accompanying drawings.

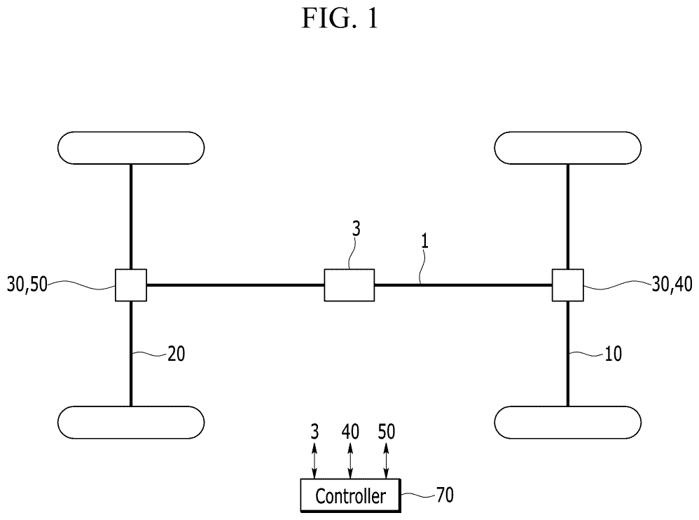

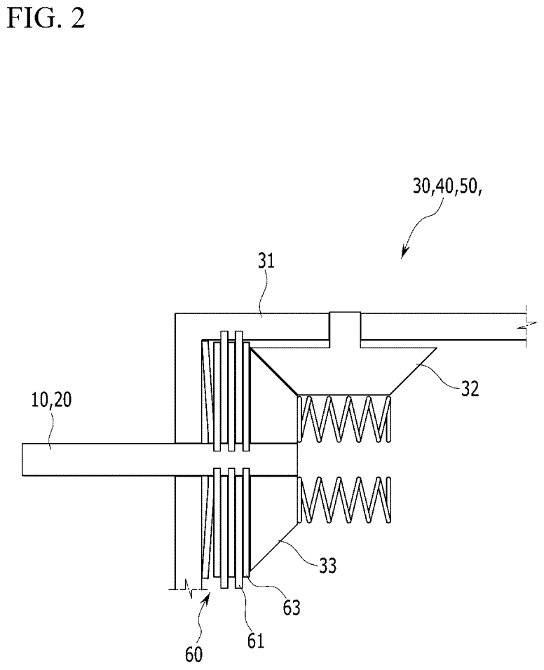

FIG. 1 is a conceptual view exemplarily illustrating a configuration of a vehicle according to an exemplary embodiment of the present disclosure. Furthermore, FIG. 2 is a block diagram illustrating the configuration of the vehicle according to an exemplary embodiment of the present disclosure.

As illustrated in FIG. 1 and FIG. 2, the vehicle according to various exemplary embodiments of the present disclosure may include limited slip differentials 40 and 50, and a controller 70 controlling torque limit values of the limited slip differentials 40 and 50.

The limited slip differentials 40 and 50 may include a first electric limited slip differential 40 provided on a first driveshaft 10 (e.g., a driveshaft of a front wheel) of the vehicle, and a second electric limited slip differential 50 provided on a second driveshaft 20 (e.g., a driveshaft of a rear wheel).

An electric limited slip differential (eLSD) may limit differential actions of a left wheel and a right wheel generated by a differential apparatus 30. That is, the electric limited slip differentials 40 and 50 may limit that a speed difference between the left wheel and the right wheel is generated by the differential apparatus 30.

The differential apparatus 30 is provided on each of the first driveshaft 10 and the second driveshaft 20, and a left wheel and a right wheel of each of the first driveshaft 10 and the second driveshaft 20 may rotate at different velocities by the differential apparatus 30. The differential apparatus 30 generates a difference in rotation speed between a turn internal wheel and a turn external wheel when the vehicle is turn-driven.

However, when the vehicle is driven on a road in which a friction coefficient of a road surface being in contact with the left wheel and a friction coefficient of a road surface being in contact with the right wheel are different each other, excessive power may be transferred to a wheel of a low-friction road (e.g., an ice road) having a relatively small friction coefficient by the differential apparatus 30, and no power is relatively transferred to a wheel of a high-friction road including a large friction coefficient. In the instant case, when the wheel of the low-friction road exceeds a limited driving force, a slip occurs in the wheel of the low-friction road. To prevent this, the limited slip differentials 40 and 50 limit the speed difference between the left wheel and the right wheel generated by the differential apparatus 30 (or synchronize the velocities of the left wheel and the right wheel) to limit transfer of excessive power to the wheel being in contact with the low-friction road.

The electric limited slip differentials 40 and 50 may synchronize the left wheel and the right wheel through a clutch 60 when the speed difference between the left wheel and the right wheel occurs.

The clutch 60 may include a clutch plate 61 and a friction plate 63. The clutch plate 61 may be connected to a side gear (or a differential gear) 33 of the differential apparatus 30, and the friction plate 63 of the clutch 60 may be connected to a differential case 31. Accordingly, when the limited slip differentials 40 and 50 are actuated, the left wheel and the right wheel may be synchronized by torques applied to the clutch plate 61 and the friction plate 63 of the clutch 60. A spider gear 32 may rotate and revolve around the driveshaft 10. The spider gear may be gear-engaged with the side gear 33, and the side gear 33 may be rotate with the rotation of the spider gear 32.

When a maximum torque is applied to the clutch 60 of the electric limited slip differentials 40 and 50, the left and right wheels are completely synchronized, and the left and right wheels rotate at the same speed. In the instant case, the differential apparatus 30 is actuated as a lock-up differential.

When the torque is not applied to the clutch 60 of the electric limited slip differentials 40 and 50, the left and right wheels are not synchronized, and the left and right wheels rotate at different velocities according to a driving situation. In the instant case, the differential apparatus 30 is actuated as an open differential.

As the torque applied to the clutch 60 of the electric limited slip differentials 40 and 50 increases, relatively large power may be transferred to the wheel being in contact with the high-friction road from a driving source 3 through a vehicle shaft 1 and the differential apparatus 30. Furthermore, as the torque applied to the clutch 60 decreases, the relatively large power may be transferred to the wheel being in contact with the low-friction road from the driving source 3 through the vehicle shaft 1 and the differential apparatus 30.

The controller 70 may be configured for controlling a torque limit value of the first electric limited slip differential 40 and a torque limit value of the second electric limited slip differential 50 based on a difference between an axial load of the first driveshaft 10 and an axial load of the second driveshaft 20.

Here, the torque limit value may mean the maximum torque which may be applied to the clutch 60 of the limited slip differentials 40 and 50.

In a normal state, the torque limit value may be a maximum torque allowed in specifications of the limited slip differentials 40 and 50. When the torque limit value is reduced, the torque which may be applied to the clutch 60 of the limited slip differentials 40 and 50 may be smaller than the maximum torque.

To the present end, the controller 70 may be implemented as one or more processors which operate by a set program, and a memory of the controller 70 stores program instructions programmed to perform each step of the method of controlling the vehicle according to an exemplary embodiment of the present disclosure through one or more processors.

Hereinafter, the method of controlling the vehicle according to an exemplary embodiment will be described in detail with reference to the accompanying drawings.

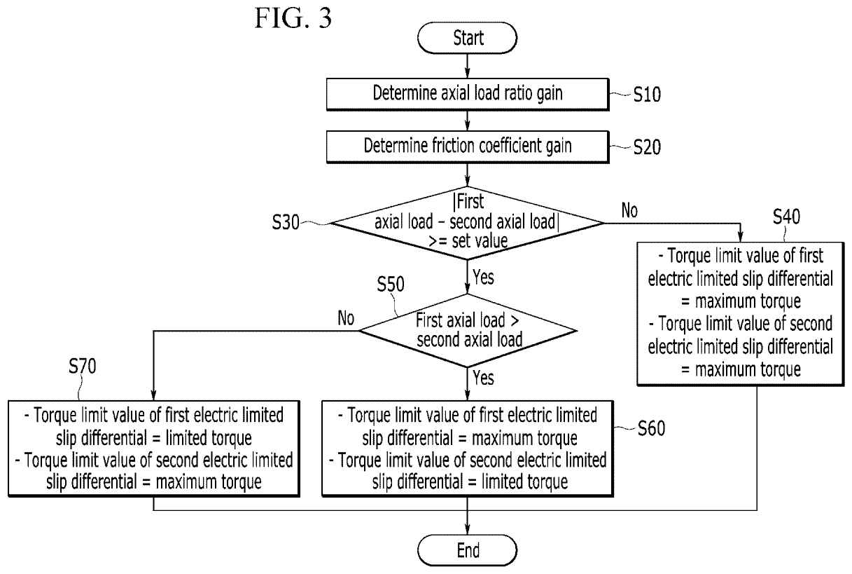

FIG. 3 is a flowchart illustrating a method of controlling a vehicle according to an exemplary embodiment of the present disclosure.

Referring to FIG. 3, the controller 70 may be configured to determine an axial load (hereinafter, referred to ‘first axial load’ as necessary) of the first driveshaft 10 and an axial load (hereinafter, referred to as ‘second axial load’ as necessary) of the second driveshaft 20.

A first axial load and a second axial load may be determined from a specification of the vehicle, which includes a longitudinal acceleration and a transverse acceleration of the vehicle, and weights of a wheel base and the vehicle. A method of determining the first axial load and the second axial load is an already known technology, and a detailed description thereof will be omitted.

The controller 70 may be configured to determine an axial load ratio from the first axial load and the second axial load, and determine an axial load ratio gain from the axial load ratio (S10).

The torque limit values of the electric limited slip differentials 40 and 50 may be reduced according to the axial load ratio gain. The axial load ratio gain may include a value between 0 and 1, and may be close to 0 as the axial load ratio is smaller.

For example, when the first axial load and the second axial load are equal to each other (for example, when the vehicle is driven on a flatland), the axial load ratio becomes 1, and in the instant case, the axial load ratio gain may become ‘1’. When the first axial load is smaller than the second axial load (for example, when the vehicle is driven on an uphill road), the axial load ratio becomes 0.7, and in the instant case, the axial load ratio gain may become ‘0.75’.

The controller 70 may be configured to determine a road surface friction coefficient of the road. The road surface friction coefficient of the road may be determined from a wheel speed and a vehicle speed. A method of determining the road surface friction coefficient of the road is an already known technology, and a detailed description thereof will be omitted.

The controller 70 may be configured to determine a friction coefficient gain from the road surface friction coefficient of the road (S20). The torque limit values of the electric limited slip differentials 40 and 50 may be reduced according to the friction coefficient gain. The friction coefficient gain may include a value between 0 and 1, and may be close to 0 as the friction coefficient of the road surface is smaller.

The controller 70 may compare a difference between the first axial load and the second axial load (S30).

When the difference between the first axial load and the second axial load is less than a predetermined value, the controller 70 may set the torque limit value of the first electric limited slip differential 40 to the maximum torque, and set the torque limit value of the second electric limited slip differential 50 to the maximum torque (S40). Here, the maximum torque may mean a torque allowed to be maximum in the specifications of the electric limited slip differentials 40 and 50.

When the difference between the first axial load and the second axial load is less than the predetermined value (when the difference between the first axial load and the second axial load is not large), the torque limit values of the first electric limited slip differential 40 and the second electric limited slip differential 50 are set to the maximum torque to continuously transfer a maximum driving force to the wheel.

When the difference between the first axial load and the second axial load is equal to or greater than the predetermined value, the controller 70 may set the torque limit values of the electric limited slip differentials 40 and 50 provided on a driveshaft including a larger axial load between the first driveshaft 10 and the second driveshaft 20 to the maximum torque, and set the torque limit values of the electric limited slip differentials 40 and 50 provided on a driveshaft including a smaller axial load between the first driveshaft 10 and the second driveshaft 20 to a limited torque. Here, the limited torque may be smaller than the maximum torque.

When the first axial load is greater than the second axial load (S50), the controller 70 may set the torque limit value of the first electric limited slip differential 40 to the maximum torque, and set the torque limit value of the second electric limited slip differential 50 to the limited torque (S60).

Contrary to this, when the first axial load is smaller than the second axial load (S50), the controller 70 may set the torque limit value of the first electric limited slip differential 40 to the limited torque, and set the torque limit value of the second electric limited slip differential 50 to the maximum torque (S70).

The limited torque may be determined according to the maximum torques, the axial load ratio gains, and the friction coefficient gains of the electric limited slip differentials 40 and 50. The limited torque may be determined through the following equation.

$${T}_{lim} = Cf * Cm * {T}_{max} \qquad [ Equation 1 ]$$

Where Tₗᵢₘ may be the limited torque, Cf may be the axial load ratio gain, Cm may be the friction coefficient gain, and Tₘₐₓ may be the maximum torque of the electric limited slip differential.

When the first axial load and the second axial load deviate from a predetermined level or more than the predetermined level, the electric limited slip differentials 40 and 50 including the larger axial load may use the maximum torque allowed in the specification. Furthermore, the electric limited slip differentials 40 and 50 including the smaller axial load may use the limited torque smaller than the maximum torque.

An operation of the vehicle according to an exemplary embodiment will be described in detail with reference to the accompanying drawings.

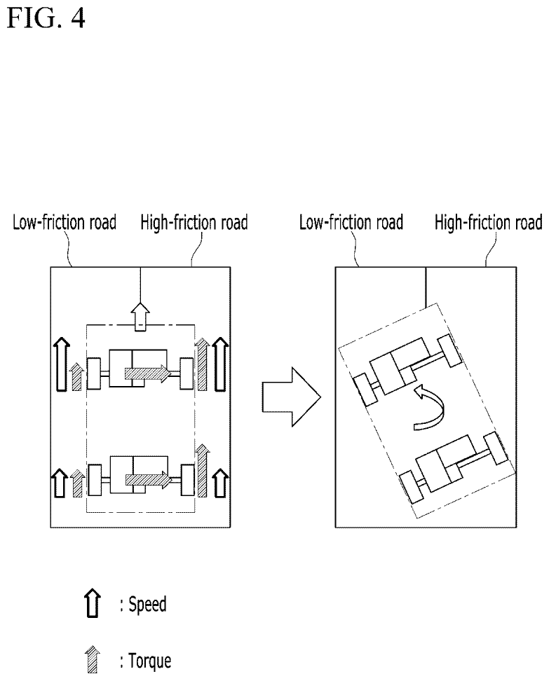

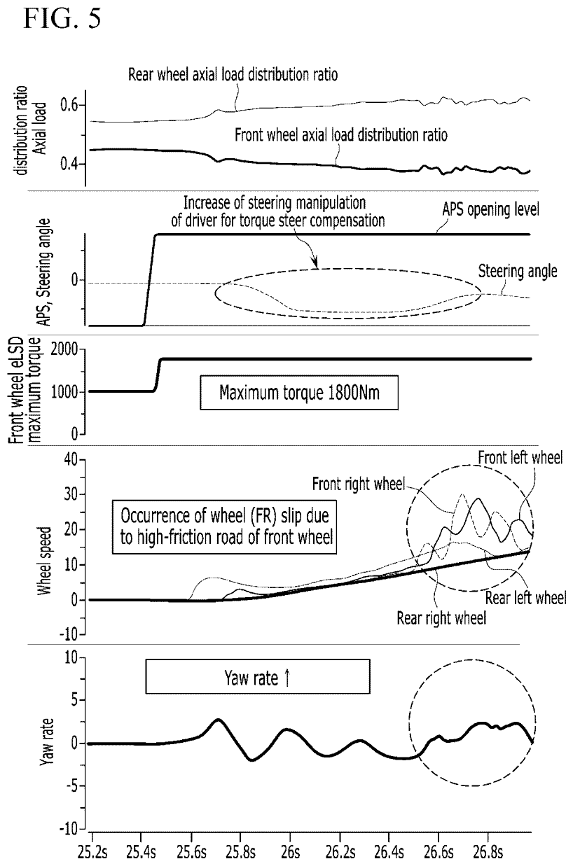

FIG. 4 is a diagram illustrating a behavior of the vehicle in a situation in which the method of controlling a vehicle according to an exemplary embodiment of the present disclosure is not applied. Furthermore, FIG. 5 is a diagram illustrating experimental data when the method of controlling a vehicle according to an exemplary embodiment of the present disclosure is not applied.

Referring to FIG. 4 and FIG. 5, there may be a situation in which the vehicle is driven on the uphill road, and a situation in which left and right friction coefficients of the road are different are illustrated. For example, there may be a situation in which the friction coefficient of the road (low-friction road) being in contact with the left wheel is relatively small and the friction coefficient of the road (high-friction load) being in contact with the right wheel is relatively large. That is, the road being in contact with the left wheel is the low-friction road, and the road being in contact with the right wheel is the high-friction road.

In the situation in which the vehicle is driven on the uphill road, the axial load of the first driveshaft 10 (front-wheel driveshaft) is smaller than the axial load of the second driveshaft 20 (rear-wheel driveshaft). Furthermore, a limited driving force of the left wheel being in contact with the low-friction load is relatively smaller than the limited driving force of the right wheel being in contact with the high-friction road. Here, the limited driving force may mean a maximum driving force of the wheel in which the wheel is not slipped.

When the vehicle takes off, the first electric limited slip differential 40 and the second electric limited slip differential 50 synchronize front left and right wheels and rear left and right wheels without considering the axial loads of the first driveshaft 10 and the second driveshaft 20. In the instant case, an excessive torque may be transferred to a front wheel having a relatively small axial load, and the front left and right wheels may be synchronized by the first limited slip differential 40. As the front left and right wheels are synchronized, an excessive torque of the limited driving force or more may be transferred to the right wheel being in contact with a front high-friction road, and the right wheel being in contact with the front high-friction road is slipped. Accordingly, a force of the vehicle which is able to endure in a transverse direction is reduced, a torque steer is generated, and a transverse behavior of the vehicle not intended by the driver occurs.

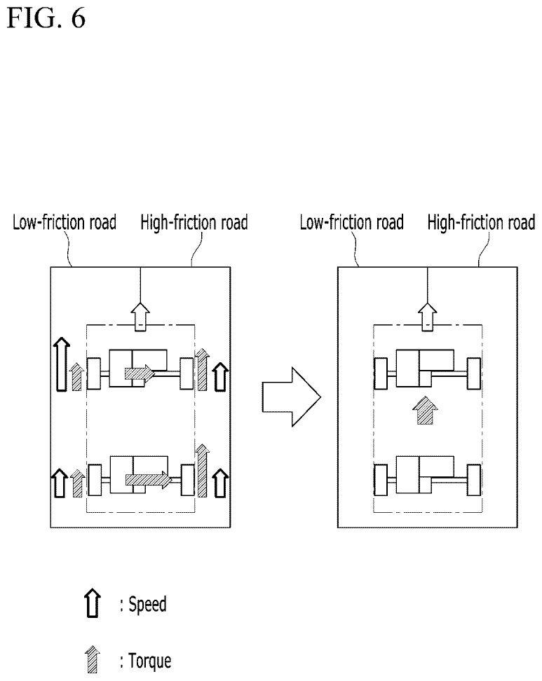

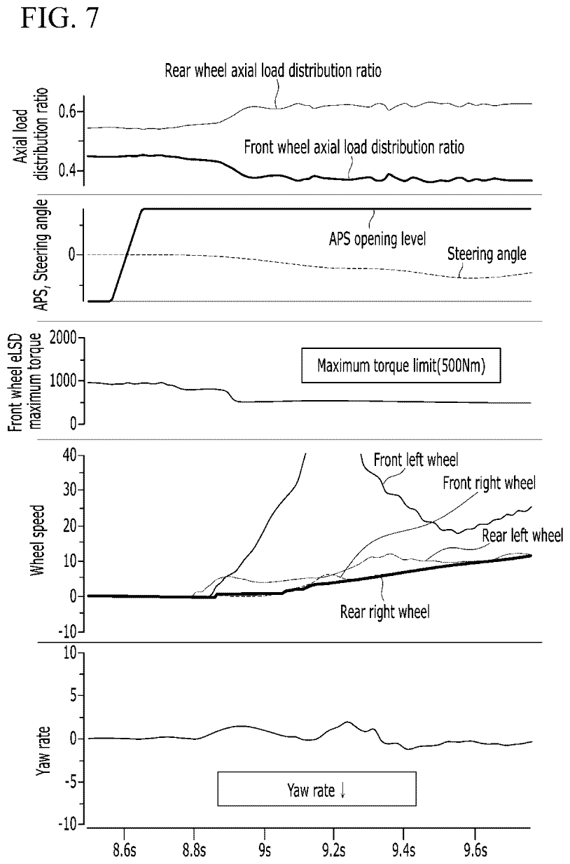

FIG. 6 is a diagram illustrating the behavior of the vehicle in a situation in which the method of controlling a vehicle according to an exemplary embodiment of the present disclosure is applied. Furthermore, FIG. 7 is a diagram illustrating the experimental data in the situation in which the method of controlling a vehicle according to an exemplary embodiment of the present disclosure is applied. FIG. 6 illustrates in a situation in which the method of controlling the vehicle according to an exemplary embodiment of the present disclosure is applied in the same situation as FIG. 4.

Referring to FIG. 6 and FIG. 7, when the vehicle takes off, the first electric limited slip differential 40 may preemptively set a torque limit value of the front wheel to the limited torque based on the axial load of the vehicle.

When the vehicle takes off, the first electric limited slip differential 40 may synchronize the left wheel and the right wheel of the front wheel, and the second electric limited slip differential 50 may synchronize the left wheel and the right wheel of the rear wheel.

In the instant case, the controller 70 estimates the road surface friction coefficient in real time to additionally reduce the torque limit value of the first electric limited slip differential 40.

As a result, the torque smaller than the limited driving force may be transferred to the first driveshaft 10 including the relatively small axial load, and in the state in which the front right wheel being in contact with the high-friction road is not slipped, the vehicle may be driven on the uphill road.

According to an exemplary embodiment of the present disclosure, by controlling the torque limit values of the first and second limited slip differentials based on the loads applied to the driveshaft of the front wheel and the driveshaft of the rear wheel of the vehicle, driving performances upon traction driving and turn driving of the vehicle may be enhanced.

Furthermore, the wheel slip of the vehicle is controlled not to occur through the first limited slip differential and the second limited slip differential to minimize intervention of automatic control by the driver, and enhance convenience of the driver.

Furthermore, because wheels spins of both the front wheel and the rear wheel are suppressed upon the traction driving, and maximum driving force according to the road surface may be used, takeoff performance and rush route escape performance of the vehicle may be enhanced, and the vehicle may be driven in a direction according to the intention of the driver.

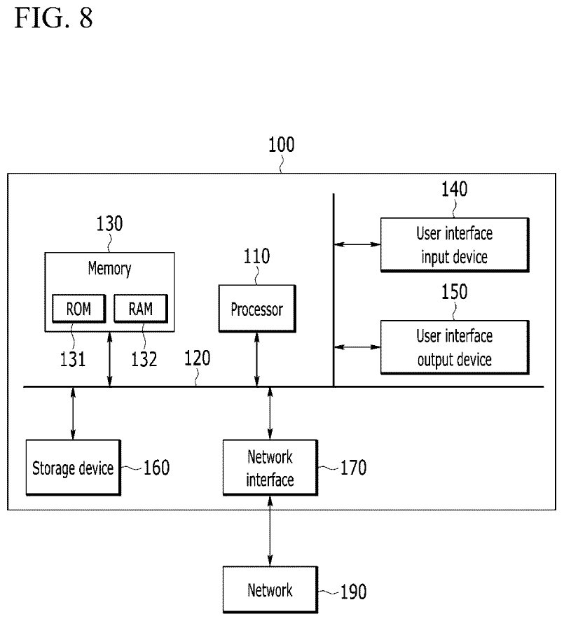

FIG. 8 is a diagram describing a computing device according to an exemplary embodiment of the present disclosure.

Referring to FIG. 8, the method of controlling the vehicle according to various exemplary embodiments of the present disclosure may be implemented by use of the computing device 100.

The computer device 100 may include at least one of a processor 110, a memory 130, a user interface input device 140, a user interface output device 150, and a storage device 160 which communicate with each other through a bus 120. The computing device 100 may also include a network interface 170 electrically connected to a network 190. The network interface 170 may transmit or receive a signal to or from another entity through the network 190.

The processor 110 may be implemented as various types including a micro controller unit (MCU), an application processor (AP), a central processing unit (CPU), a graphic processing unit (GPU), and a neural processing unit (NPU), and may be an arbitrary semiconductor device that executes an instruction stored in the memory 130 or the storage device 160. The processor 110 may be configured to implement the functions and methods in relation to FIGS. 1 to 7.

The memory 130 and the storage device 160 may include various types of volatile or non-volatile storage media. For example, the memory may include a read only memory (ROM) 131 and a random access memory (RAM) 132. In the exemplary embodiment of the present disclosure, the memory 130 may be positioned inside or outside the processor 110 and connected to the processor 110 by various well-known means.

In some exemplary embodiments of the present disclosure, at least some components or functions of the vehicle and the method of controlling the same according to the exemplary embodiments of the present disclosure may be implemented as a program or software executed by the computing device 100 or the program or software may be stored in a computer readable medium.

In some exemplary embodiments of the present disclosure, at least some components or functions of the method of controlling the vehicle according to the exemplary embodiments of the present disclosure may be implemented by use of hardware or a circuit of the computing device 100 or as a separate hardware or circuit which may be electrically connected to the computing device 100.

The control device may be at least one microprocessor operated by a predetermined program which may include a series of commands for carrying out the method included in the aforementioned various exemplary embodiments of the present disclosure.

In various exemplary embodiments of the present disclosure, each operation described above may be performed by a control device, and the control device may be configured by a plurality of control devices, or an integrated single control device.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A vehicle comprising:
a first electric limited slip differential provided on a first driveshaft, and limiting differential actions of a left wheel and a right wheel of the first driveshaft;
a second electric limited slip differential provided on a second driveshaft, and limiting differential actions of a left wheel and a right wheel of the second driveshaft; and
a controller operatively connected to the first and second electric limited slip differentials and configured for controlling a torque limit value of the first electric limited slip differential and a torque limit value of the second electric limited slip differential based on a difference between an axial load of the first driveshaft and an axial load of the second driveshaft.

2. The vehicle of claim 1, wherein
in response that the difference between the axial load of the first driveshaft and the axial load of the second driveshaft is less than a predetermined value,
the controller is configured to:
set the torque limit value of the first electric limited slip differential to a maximum torque, and
set the torque limit value of the second electric limited slip differential to the maximum torque.

3. The vehicle of claim 1, wherein
in response that the difference between the axial load of the first driveshaft and the axial load of the second driveshaft is equal to or greater than the predetermined value,
the controller is configured to:
set a torque limit value of an electric limited slip differential provided in a driveshaft including a larger axial load between the first driveshaft and the second driveshaft among the first and second electric limited slip differentials, to the maximum torque, and
set a torque limit value of an electric limited slip differential provided in a driveshaft including a smaller axial load between the first driveshaft and the second driveshaft among the first and second electric limited slip differentials, to a limited torque smaller than the maximum torque.

4. The vehicle of claim 3, wherein the limited torque is determined by the maximum torque of the electric limited slip differential by an axial load ratio gain determined according to the axial load of the first driveshaft and the axial load of the second driveshaft, and a friction coefficient gain determined according to a road surface friction coefficient of a road.

5. The vehicle of claim 4,
wherein the limited torque is determined through an equation of Tₗᵢₘ=Cf*Cm*Tₘₐₓ, and
wherein Tₗᵢₘ represents the limited torque, Cf represents the axial load ratio gain, Cm represents the friction coefficient gain, and Tₘₐₓ represents the maximum torque of the electric limited slip differential.

6. The vehicle of claim 4, wherein the axial load ratio gain decreases as a ratio of the axial load of the first driveshaft and the axial load of the second driveshaft decreases.

7. The vehicle of claim 4, wherein the friction coefficient gain decreases as the road surface friction coefficient of the road decreases.

8. A method of controlling a vehicle, the method comprising:
comparing, by a controller, an axial load of a first driveshaft and an axial load of a second driveshaft; and
controlling, by the controller, a torque limit value of a first electric limited slip differential provided on the first driveshaft and operatively connected to the controller and a torque limit value of a second electric limited slip differential provided on the second driveshaft and operatively connected to the controller, based on a difference between the axial load of the first driveshaft and the axial load of the second driveshaft.

9. The method of claim 8, wherein
in response that the difference between the axial load of the first driveshaft and the axial load of the second driveshaft is less than a predetermined value,
the torque limit value of the first electric limited slip differential is set by the controller to a maximum torque, and
the torque limit value of the second electric limited slip differential is set by the controller to the maximum torque.

10. The method of claim 8, wherein
in response that the difference between the axial load of the first driveshaft and the axial load of the second driveshaft is equal to or greater than the predetermined value,
a torque limit value of an electric limited slip differential provided in a driveshaft including a larger axial load between the first driveshaft and the second driveshaft among the first and second electric limited slip differentials, is set by the controller to the maximum torque, and
a torque limit value of an electric limited slip differential provided in a driveshaft including a smaller axial load between the first driveshaft and the second driveshaft among the first and second electric limited slip differentials, is set by the controller to a limited torque smaller than the maximum torque.

11. The method of claim 10, wherein the limited torque is determined by the maximum torque of the electric limited slip differential by an axial load ratio gain determined according to the axial load of the first driveshaft and the axial load of the second driveshaft, and a friction coefficient gain determined according to a road surface friction coefficient of a road.

12. The method of claim 11,
wherein the limited torque is determined through an equation of Tₗᵢₘ=Cf*Cm*Tₘₐₓ, and
wherein Tₗᵢₘ represents the limited torque, Cf represents the axial load ratio gain, Cm represents the friction coefficient gain, and Tₘₐₓ represents the maximum torque of the electric limited slip differential.

13. The method of claim 12, wherein the axial load ratio gain decreases as a ratio of the axial load of the first driveshaft and the axial load of the second driveshaft decreases.

14. The method of claim 12, wherein the friction coefficient gain decreases as the road surface friction coefficient of the road decreases.
